(19) United States
(12) Patent Application Publication
(10) Pub. No.: US 2012/0145734 A1
(43) Pub. Date: Jun. 14, 2012

(54) SCREW DRIVE FOR DISPENSING CUTLERY AND RELATED METHODS

(75) Inventor: Richard S. Walters, Port Washington, WI (US)

(73) Assignee: DIXIE CONSUMER PRODUCTS LLC, Atlanta, GA (US)

(21) Appl. No.: 13/284,215

(22) Filed: Oct. 28, 2011

Related U.S. Application Data
(60) Provisional application No. 61/422,004, filed on Dec. 10, 2010.

(51) Int. Cl. B65G 59/00; B65D 83/00

(52) U.S. Cl. 221/1; 221/191

(57) ABSTRACT

A dispenser for dispensing cutlery may include a housing configured to contain a plurality of utensils for dispensing, a dispensing mechanism that includes at least one threaded separating member configured to be driven and separate a utensil from a stack of utensils, and at least one drive mechanism configured to drive the at least one threaded separating member. The dispenser may further include a receptacle configured to receive the utensil separated from the stack of utensils.

### CROSS-REFERENCE TO RELATED APPLICATION

This application claims priority to U.S. Provisional Patent Application No. 61/422,004 filed Dec. 10, 2010, the disclosure of which is incorporated herein in its entirety by this reference.

### FIELD OF THE DISCLOSURE

The present disclosure relates to dispensing cutlery. In particular, the present disclosure relates to dispensers for dispensing utensils, dispensing mechanisms for dispensing utensils, and related methods.

### BACKGROUND

Disposable cutlery may be provided as a less expensive alternative to reusable cutlery, for example, at restaurants and social gatherings where it is undesirable or cost prohibitive to clean the cutlery for reuse. However, providing disposable cutlery may present a number of potential drawbacks related to the nature in which it is dispensed.

For example, providing disposable cutlery in a loose or unpackaged fashion, such as in loose form in a receptacle containing the disposable cutlery, may result in patrons taking more cutlery than necessary, thereby increasing the cost of providing the cutlery. In addition, providing loose or unpackaged cutlery may present concerns regarding whether dispensing cutlery in such a manner is hygienic. As a result, it may be desirable to dispense disposable cutlery in a manner other than in a loose or unpackaged form.

The above-noted concerns may be addressed by dispensing disposable cutlery from dispensers configured to contain a supply of the cutlery and dispense a disposable utensil upon operation of a patron. However, the complexity and expense of many dispensers may reduce the benefit to the purchaser of the dispenser. Thus, it may be desirable to provide a simple and reliable dispenser in order to further reduce costs and increase efficiency.

In addition, it may be desirable to provide a dispenser that is capable of dispensing utensils without flipping or otherwise altering the orientation of the utensils during the dispensing process. For example, some dispensers may cause utensils to flip or rotate within the dispenser as a stack of the utensils slides within the dispenser, which may lead to jamming the dispenser, thereby potentially compromising its utility.

Additionally, it may be desirable to provide a dispenser capable of reliably dispensing utensils. Dispensers that lack a reliable dispensing mechanism may have a tendency to cause patrons to unintentionally dispense more than one utensil at a time and/or jam the dispenser such that no utensils can be dispensed until the dispenser is manually un-jammed. This may result in compromising one of the potential advantages of dispensing utensils via a dispenser—reducing costs associated with patrons taking more utensils than necessary.

Thus, it is desirable to provide a system and method for addressing one or more of the potential drawbacks discussed above.

### SUMMARY

In the following description, certain aspects and embodiments will become evident. It should be understood that the aspects and embodiments, in their broadest sense, could be practiced without having one or more features of these aspects and embodiments. Thus, it should be understood that these aspects and embodiments are merely exemplary.

One aspect of the disclosure relates to a dispenser for dispensing cutlery. The dispenser may include a housing configured to contain a plurality of utensils for dispensing, a dispensing mechanism that includes at least one threaded separating member configured to be driven and separate a utensil from a stack of utensils, and at least one drive mechanism configured to drive the at least one threaded separating member. According to some embodiments, the at least one threaded separating member may interact with the shape of the utensil. For example, the positioning of the at least one threaded separated members may depend on the shape of the utensil rather than the location of other threaded separating members. The dispenser may further include a receptacle configured to receive the utensil separated from the stack of utensils. As used herein, “stack” does not necessarily mean a vertical stack, such that a group of nested, coupled, or similarly oriented utensils may extend at any angle ranging from horizontal to vertical.

Another aspect relates to a method for dispensing cutlery from a dispenser. The method may include providing a plurality of utensils for dispensing, indexing at least one threaded separating member such that a utensil is separated from the stack of utensils, and providing access to the utensil separated from the stack of utensils.

### BRIEF DESCRIPTION OF THE DRAWINGS

The accompanying drawings, which are incorporated in and constitute a part of this description, illustrate several embodiments and together with the description, serve to explain principles of the embodiments. In the drawings,

FIG. 1 is a schematic perspective view of an embodiment of a dispenser for dispensing utensils.

FIG. 2 is a schematic perspective view of a dispensing mechanism and a stack of utensils.

FIG. 3 is a schematic partial perspective cross-sectional view of a dispensing mechanism and a stack of utensils.

### DETAILED DESCRIPTION OF EMBODIMENTS

Reference will now be made in detail to various embodiments. Wherever possible, the same reference numbers are used in the drawings and the description to refer to the same or like parts.

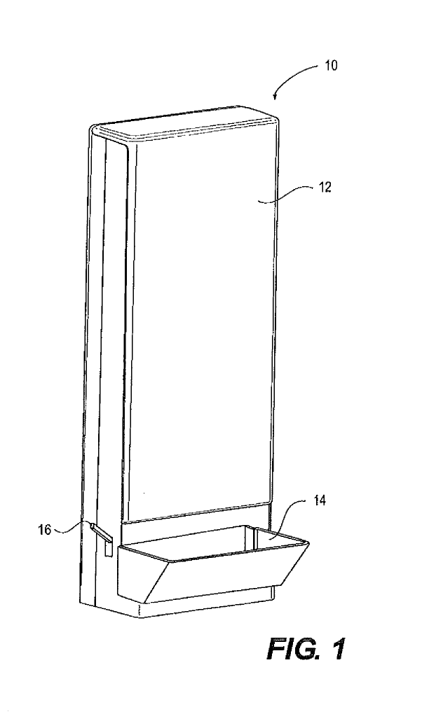

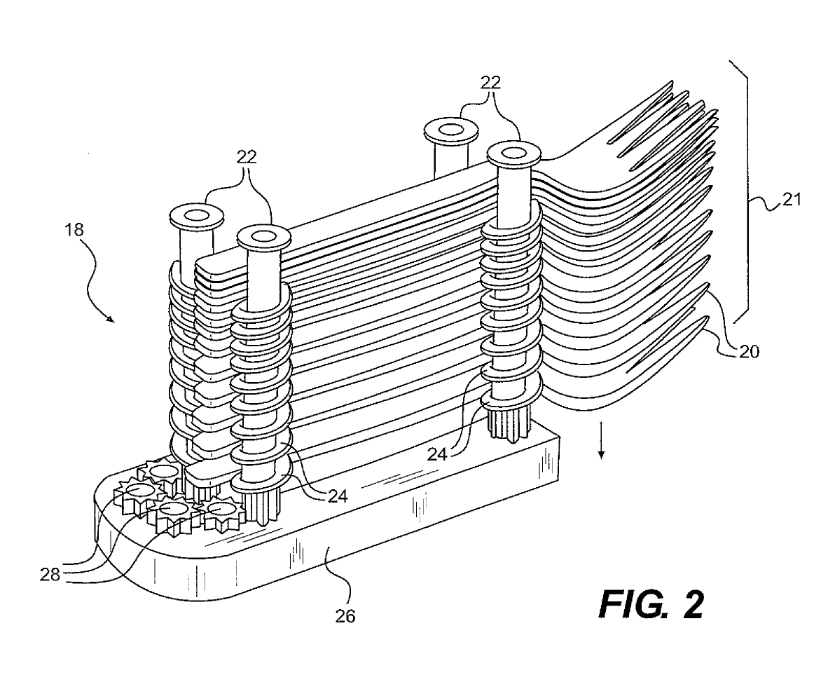

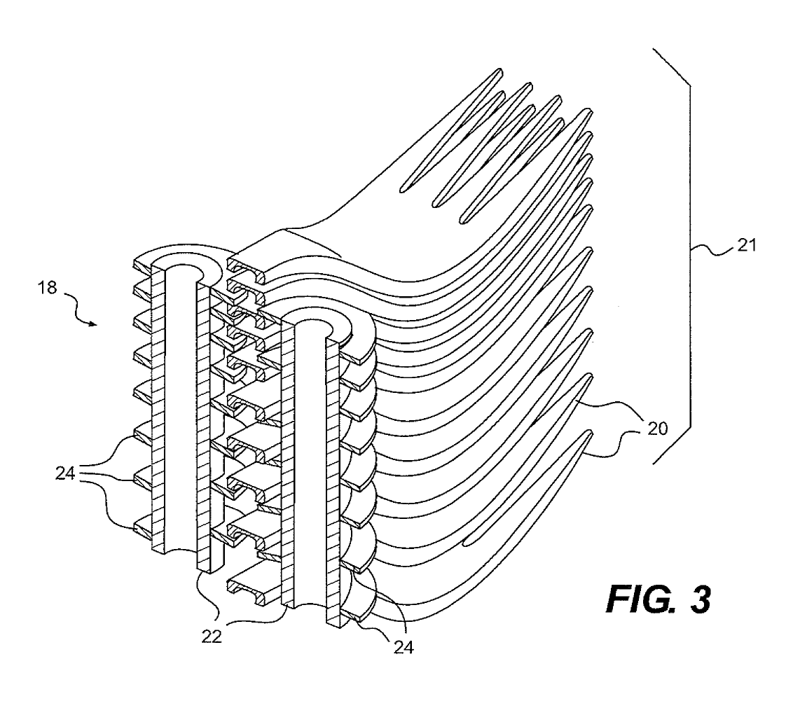

FIG. 1 shows a schematic perspective view of a dispenser 10 for dispensing utensils 20. Dispenser 10 includes a housing 12 configured to store a plurality of utensils 20 (see FIGS. 2 and 3). Housing 12 may be configured to receive utensils 20 in various arrangements. For example, housing 12 may be configured to receive one or more of loose utensils, cartridges containing utensils, stacks of utensils bound by a wrapper, and/or stacks of utensils removably coupled to one another. For example, housing 12 may include a chute configured to receive a plurality of utensils 20 in a stack 21. The chute of housing 12 may feed a dispensing mechanism 18 (see, e.g., FIGS. 2 and 3), which is configured to dispense at least one utensil 20, for example, individually. According to some embodiments, the stack 21 of utensils 20 may extend at any angle ranging from horizontal to vertical.

Dispenser 10 includes a receptacle 14 configured to receive utensils 20 dispensed from housing 12 by a dispensing mechanism 18. Dispensing mechanism 18 may be located inside dispenser 10. In some embodiments, dispensing mechanism 18 is located inside housing 12. Dispenser 10 may include an actuator 16 for operation of dispenser 10 by a user. Actuator 16 may be configured to activate dispensing mechanism 18 in order to dispense a utensil 20 from a stack 21 of utensils in housing 12. While FIG. 1 shows actuator 16 in the form of a handle, actuator 16 may be provided in any suitable form, for example, a rotatable knob, a button, a switch, a bar, an electronic sensor (e.g., a proximity sensor), and/or a crank. Additionally, according to some embodiments, actuator 16 may be incorporated into other aspects of dispenser 10. For example, actuator 16 may be incorporated into receptacle 14, such that a user may activate actuator 16 by manipulating receptacle 14 directly in order to operate dispensing mechanism 18. In some embodiments, actuator 16 may be incorporated into other aspects of dispenser 10, such as, for example, housing 12.

FIG. 2 shows a schematic perspective view of dispensing mechanism 18 and a stack 21 of utensils. Utensils 20 are shown as forks, but may be provided in any suitable form, for example, spoons, knives, and/or sporks. In some embodiments, utensils 20 may have variable cross-sectional shapes, such that, for example, the portion of utensil 20 that is anticipated to contact dispensing mechanism 18 may be shaped to facilitate dispensing (e.g., it may have a handle portion that is generally consistent in cross-sectional shape over a portion of utensil 20), while other portions of utensil 20 may have different cross-sectional shapes. Utensils 20 may be constructed from a formable material. The formable material may include, for example, plastic, combinations of plastics, or combinations of plastics and other materials suitable for use as disposable or reusable cutlery. For example, the formable material may include one or more of polystyrene, polyethylene, and polypropylene.

According to some embodiments, dispensing mechanism 18 may facilitate the dispensing of utensils 20 from a stack 21 of utensils. In particular, dispensing mechanism 18 may be configured to retain a plurality of utensils 20 inside housing 12 until a user operates actuator 16 of dispenser 10. During operation in one embodiment, dispensing mechanism 18 may separate at least one utensil 20 from a stack 21 of utensils and allow the at least one utensil 20 to proceed, for example, via gravity, from dispensing mechanism 18 to receptacle 14, where it may be received by a user. In some embodiments, dispensing mechanism 18 may be operated via actuator 16. For example, a user may operate actuator 16 in a downward direction in order to operate dispensing mechanism 18 and dispense utensil 20. The method of operating actuator 16 in order to operate dispensing mechanism 18 may depend on the form of actuator 16, which may be provided in any suitable form, for example, a rotatable knob, a button, a switch, a bar, an electronic sensor, and/or a crank.

Dispensing mechanism 18 of FIG. 2, is shown with two pairs of threaded separating members 22 associated with a stack 21 of utensils with the two pairs of threaded separating members 22 being spaced from one another along the longitudinal length of the utensils 20. According to some embodiments, threaded separating member 22 may include external threading 24 that at least partially surrounds a portion of threaded separating member 22. For example, the threaded separating member 22 of FIG. 2 includes external threading 24 that partially surrounds a lower portion of threaded separating member 22. In some embodiments, threaded separating member 22 may engage at least one utensil 20 via at least a portion of external threading 24. For example, a portion of external threading 24 may be configured to engage the stack 21 of utensils by being located between individual utensils 20. According to some embodiments, at least a portion of threaded separating member 22 may be configured to support a portion of the stack 21 of utensils without engaging that portion of the stack 21 of utensils via external threading 24. For example, as shown in FIG. 2, an upper portion of threaded separating members 22 that lacks external threading 24 may support a portion of the stack 21 of utensils by abutting at least one utensil 20. Although dispensing mechanism 18 is shown with two pairs of threaded separating members 22 in FIG. 2, dispensing mechanism 18 may use any suitable number of threaded separating members 22, including one. For example, stack 21 may abut a surface on one side, allowing one threaded separating member 22 to dispense utensils 20 from the stack 21.

According to some embodiments, threaded separating members 22 may operate in pairs. For example, a pair of threaded separating members 22 may be positioned such that the stack of utensils may be received between the pair of threaded separating members 22. In some embodiments, dispensing mechanism 18 may operate more efficiently when pairs of threaded separating members 22 rotate at a substantially similar rate.

According to some embodiments, a drive mechanism 26 may be operably coupled to one or more threaded separating members 22, such that the one or more threaded separating members 22 may be driven. For example, drive mechanism 26 may be operably coupled to at least one threaded separating member 22 via at least one gear 28 operably coupled to drive mechanism 26 and the at least one threaded separating member 22. For example, FIG. 2 shows drive mechanism 26 associated with four gears 28 that may operate to rotate at least one pair of threaded separating members 22 at similar speeds. In some embodiments, additional drive mechanisms 26 or additional gears 28 may be associated with the threaded separating members 22 shown in FIG. 2, or with additional threaded separating members 22. In some embodiments, gears 28 may allow multiple pairs of threaded separating members 22 to rotate at a substantially similar speed, thereby providing a desired operation of dispensing mechanism 18.

Drive mechanism 26 may comprise any type of mechanism that transfers force to gears 28 via actuation of actuator 16. According to some embodiments, drive mechanism 26 may include an electric motor associated with actuator 16, for example, an actuator in the form of a proximity sensor. Alternatively, actuator 16 may directly index at least one gear 28. According to some embodiments, drive mechanism 26 may include manual operation by a user, such as, for example, rotation of a knob operably coupled to at least one gear 28.

According to some embodiments, dispensing mechanism 18 may separate utensil 20 from a stack of utensils by driving and/or indexing threaded separating members 22. For example, drive mechanism 26 may rotate at least one threaded separating member 22 such that external threading 24 imparts force to at least one utensil 20 engaged by external threading 24. The direction of the rotation of threaded separating member 22 may determine the direction and/or magnitude of the force applied to an engaged utensil 20. For example, threaded separating members 22 may rotate in a direction that produces a force causing at least one engaged utensil 20 to move in a dispensing direction.

In some embodiments, for example, the embodiment shown in FIG. 3, threaded separating members 22 may be configured such that the distance between adjacent external threads of external threading 24 varies over at least a portion of the threaded separating member 22. For example, the distance between adjacent external threads may gradually increase toward at least one end (e.g., the lower end) of threaded separating member 22 that dispenses utensil 20. According to some embodiments, gradually increasing distance between adjacent external threads of threaded separating members 22 may provide a desired amount of separation between utensils 20 that are to be dispensed, thereby preventing unwanted flipping or twisting of utensils 20 and/or enabling pulling apart of separably coupled utensils 20 in a controlled manner. For example, the stack 21 of utensils 20 may include separably coupled utensils 20 that are coupled by use of adhesive, spot welding, ultrasonic welding, vibration welding, soldering, hot melting, or any other suitable method. According to some embodiments, threaded separating members 22 may be configured such that external threading 24 terminates at a location where dispensing of utensil 20 from dispensing mechanism 18 is desired. After being dispensed by dispensing mechanism 18, utensil 20 may proceed to receptacle 14 (e.g., via gravity) to be received by a user.

According to some embodiments, dispensing mechanism 18 may be configured to dispense a stack 21 of utensils in an orientation other than the orientation shown in FIG. 2 (e.g., an orientation that is not a vertical orientation). For example, dispensing mechanism 18 may be configured to dispense utensils 20 from a stack 21 of utensils in a second orientation (i.e., a horizontal orientation). In some embodiments, dispensing mechanism 18 may include one or more threaded separating members 22 on only one side of the stack 21 of utensils. This orientation may be useful where, for example, the stack 21 of utensils rests on a support surface (e.g., a vertically-oriented surface, a horizontally-oriented surface, or a surface disposed at any angle in between vertical and horizontal) with one side of the stack 21 of utensils contacting the support surface. In such circumstances, a single threaded separating member 22 may be configured to dispense utensil 20 from the stack 21 of utensils. This orientation may be useful for dispensers that utilize less vertical space relative to some traditional, upright utensil dispensers.

In some embodiments, utensils 20 may be provided in the form of a cartridge or similar container. For example, a cartridge configured to be loaded into dispenser 10 may contain a stack 21 of utensils configured to be dispensed by dispensing mechanism 18. According to some embodiments, the cartridge may be shaped such that it exposes at least the portions of utensils 20 configured to come into contact with at least one threaded separating member 22. In some embodiments, the cartridge may include a first portion of threaded separating member 22, such that when the cartridge is loaded into dispenser 10 the first portion of the at least one threaded separating member 22 may be associated with at least one drive mechanism 26 and/or a second portion of at least one threaded separating member 22. For example, the first portion of the at least one threaded separating member 22 may include a portion of threaded separating member 22 without external threading 24, while the second portion of the at least one threaded separating member 22 may include external threading 24. In such an example, the portions of threaded separating member 22 may be associated with one another upon loading of the cartridge into dispenser 10. In some embodiments, the cartridge may be used to load and/or aid in loading utensils 20 and may then be removed prior to operation of dispenser 10.

It will be apparent to those skilled in the art that various modifications and variations can be made to the structures and methodologies described herein. Thus, it should be understood that the invention is not limited to the subject matter discussed in the description. Rather, the present disclosure is intended to cover modifications and variations.

What is claimed is:

1. A dispenser for dispensing cutlery, the dispenser comprising:
a housing configured to contain a plurality of utensils for dispensing;
a dispensing mechanism comprising
at least one threaded separating member configured to separate a utensil from a stack of utensils, and
a drive mechanism associated with the at least one threaded separating member and configured to drive the at least one threaded separating member; and
a receptacle configured to receive the utensil separated from the stack of utensils.

2. The dispenser of claim 1, wherein the at least one threaded separating member comprises external threads, and wherein over at least a portion of the threaded separating member the external threads are equally spaced from one another.

3. The dispenser of claim 2, wherein the at least one threaded separating member comprises external threads, and wherein a distance between adjacent external threads is non-uniform over at least a portion of the threaded separating member.

4. The dispenser of claim 1, wherein the dispensing mechanism comprises a plurality of threaded separating members configured to separate a utensil from the stack of utensils.

5. The dispenser of claim 1, wherein the dispensing mechanism comprises at least one pair of threaded separating members configured to engage the stack of utensils via opposing sides of the stack of utensils.

6. The dispenser of claim 1, wherein the dispensing mechanism is configured to separate a utensil from the stack of separably coupled utensils.

7. The dispenser of claim 1, wherein the at least one threaded separating member is configured to extend along at least a portion of the extent of the stack of utensils.

8. The dispenser of claim 1, wherein the at least one threaded separating member is configured to extend along the entire extent of the stack of utensils.

9. The dispenser of claim 1, further comprising a utensil cartridge configured to be loaded into the dispenser, the utensil cartridge comprising at least a first portion of the at least one threaded separating member and being configured to be associated with at least one of the drive mechanism and a second portion of the at least one threaded separating member upon placement of the utensil cartridge in the dispenser.

10. A method for dispensing cutlery from a dispenser, the dispenser comprising at least one threaded separating member, the method comprising:
providing a plurality of utensils for dispensing;
indexing at least one threaded separating member such that a utensil is separated from a stack of utensils; and
providing access to the utensil separated from the stack of utensils.

11. The method of claim 10, wherein providing a plurality of utensils comprises providing a plurality of separably coupled utensils.

12. The method of claim 10, wherein indexing at least one of the threaded separating members is facilitated by a drive mechanism associated with the at least one threaded separating member and configured to drive the at least one threaded separating member.

13. The method of claim 12, wherein the drive mechanism is engaged by activating an actuator operably coupled to the drive mechanism.

14. The method of claim 10, wherein indexing at least one of the threaded separating members comprises rotating the at least one threaded separating member such that a utensil is separated from the stack of utensils.

15. The method of claim 10, wherein indexing at least one threaded separating member comprises indexing at least one pair of threaded separating members positioned on opposing sides of the stack of utensils.

16. The method of claim 10, wherein indexing at least one threaded separating member provides a separating force to at least one utensil and a retaining force to at least one other utensil.

17. The method of claim 10, wherein providing a plurality of utensils for dispensing comprises providing at least one of a cartridge of utensils, a stack of separably coupled utensils, and a stack of banded utensils.

18. The method of claim 10, wherein providing access to the utensil comprises providing a receptacle positioned to receive the utensil separated from the stack of utensils.
